(19) United States
(12) Patent Application Publication
(10) Pub. No.: US 2019/0253856 A1
(43) Pub. Date: Aug. 15, 2019

(54) FILTER ELEMENT FOR A FILTER MODULE FOR FILTERING PROCESS AIR FOR A TREATMENT STATION

(71) Applicant: EISENMANN SE, Böblingen (DE)

(72) Inventors: Jürgen Röckle, Magstadt (DE); Tobias Zebisch, Sindelfingen (DE)

(21) Appl. No.: 16/300,573

(22) PCT Filed: May 8, 2017
(86) PCT No.: PCT/EP2017/060905

§ 371 Date: Nov. 11, 2018

(30) Foreign Application Priority Data
May 12, 2016 (DE) 10 2016 005 701.7

(51) Int. Cl. H04W 4/80; H04B 5/00; B01D 46/00; B01D 46/42

(52) U.S. Cl. CPC H04W 4/80; H04B 5/0062; B01D 2279/50; B01D 46/009; B01D 46/429; H04B 5/0068

(57) ABSTRACT

A filter element for a filter module for filtering process air for a treatment station, the filter element being equipped with an RFID tag.

### BACKGROUND OF THE INVENTION

### 1. Area of the Invention

The invention relates to a filter element for a filter module for filtering process air for a treatment facility.

### 2. Description of the Prior Art

Filter elements are used, for example, in filter modules of recirculating air or supply air facilities for filtering process air. In such facilities, it has to be ensured, in particular during maintenance work, that the correct filter elements are inserted into the corresponding filter modules during a replacement of filter elements for proper operation of the facility. It is not only important in this case to correctly associate the filter elements available for the replacement with the filter modules. Rather, it is of interest from the viewpoint of the facility producer and/or operator to recognize the suitability in principle of the filter element for the respective filter module.

For this purpose, filter elements are provided with type identifiers in the prior art, which identify a defined area of application of the filter element. The items of information linked to such an identifier are typically attached for this purpose in the form of bar codes or so-called QR codes to the respective filter element. While a barcode exclusively permits the coding of a sequence of numbers of limited length, it is possible to read out a longer sequence of numbers and/or letters using a QR code.

Both systems share the feature that an information flow is only possible in one direction—reading—an exact positioning between code and read device is necessary for automated operation, and a certain sensitivity in relation to soiling is inherent because of the optical reading procedure. Moreover, such optical codes are manipulable in a simple manner, and therefore checking the authenticity of the inserted filter element is not possible or is only possible to an inadequate extent.

Furthermore, to recognize the suitability of the filter element connected to the code for a specific filter module, a central database is necessary, which links the read-out code to corresponding stored parameters of the filter element and can thus establish a suitability.

A further disadvantage of the described code systems is that if a filter element is replaced before reaching the maximum service life of the filter element, it is only possible with substantial effort to store the fill level of the filter element such that in the event of a later reinsertion of the filter element, it can be associated with just this filter element and retrieved. In particular if filter elements are used in the painting field, for example, for filtering overspray, which occurs in painting booths, soiling of such a code system is often unavoidable and the information linked to the code is thus easily lost.

### SUMMARY OF THE INVENTION

It is an object of the invention to specify a filter element for a filter module for filtering process air for a treatment facility, which at least remedies the mentioned disadvantages and in particular offers enhanced reliability upon the authenticity check of a filter element and/or reliable storage of, for example, the fill level of a filter element.

The object is achieved by a filter element according to independent claim 1. Further embodiments of the invention are specified in the dependent claims.

The filter element according to the invention for a filter module for filtering process air for a treatment facility has a communication device, which has an information carrier and a transmitter and is designed for the purpose of transmitting items of information of the information carrier. The communication device can have a separate power source for the information transmission. However, it can also be provided that the power for transmitting the items of information is first transferred to the communication device upon request for the information. Items of information about the filter element can be stored in the information carrier, which are transmitted upon a request, for example, a write/read procedure. The items of information can be, for example, type-specific and/or production-specific data, which can be significant for operation of the filter element. Furthermore, the items of information can be data generated or obtained in the operation of the filter element, for example, the type and quantity of the materials with which the filter element has been charged.

The communication device can also have, in addition to the transmitter, a receiver, which can be configured to store items of information on the information carrier. Items of information relating to the filter element, for example, a fill level of a filter element or more extensive items of information such as a chronology of the filling procedure having time and pressure loss specifications, can thus be saved directly on the filter element and read out again and analyzed in the event of a later use of the filter element.

In one embodiment of the invention, it can be provided that the communication device is designed as an RFID transponder. The term “RFID” is also to comprise the technology “NFC” (NFC=near field communication) here and hereafter. The attachment of an RFID transponder to a filter element enables, in cooperation with an RFID write/read device, not only a read-out of the items of information stored in the RFID transponder, but rather also permits a transmission of items of information from the RFID write/read device to the RFID transponder. At the same time, it is possible by means of an RFID transponder to carry out a reliable authentication, i.e., a check and verification of the authenticity of the filter element. The RFID transponder is preferably passive, i.e., without a separate power supply, but can also be equipped with a power source such as a battery.

Alternatively, the communication device can be configured to transmit items of information via a WLAN and/or according to the Bluetooth standard. “WLAN” is to be understood as a wireless local area network, preferably according to the standard of the IEEE 802.11 family. “Bluetooth” is to be understood in general as a wireless personal area network and in a preferred embodiment a wireless network operating according to the industry standard IEEE 802.15.1.

A refinement of the invention provides that the communication device comprises a sensor for acquiring filter-element-specific data. In this case, the sensor can [lacuna], for example, one or more physical measured variables of the filter element

One advantageous refinement of the invention provides that the RFID transponder is configured to transmit filter-element-specific data in the event of a read-out procedure. It is thus not only possible using the filter element according to the invention to communicate a general filter element type to a filter module or a treatment facility, but rather, for example, to communicate data relating to the filter element type or even data relating to the specific filter element. Corresponding data can be obtained, for example, during the production of the filter element type or the specific filter element or can be measured after production. This enables an optimum utilization of the filter capacity of the specific filter element, without requiring an excess data overhead, for example, by means of a central database.

In this context, it can be provided that the filter-element-specific data include a curve of the pressure drop of the filter element over time. The curve of the pressure drop to be expected with increasing filling of the filter element can thus be stored in the case of the specific filter element for the individual filter element or for a filter element type and this curve can be transmittable by means of RFID communication to the treatment facility. This enables particularly reliable recognition of the fill level of a filter element and thus optimum utilization of the maximum filter capacity available in the filter element.

Alternatively or additionally, it can be provided that the filter-element-specific data are configured for an identification and/or an authentication of the filter element. A treatment facility which reads out the filter-element-specific data by means of RFID communication can thus establish whether the filter element to be inserted or already inserted in a filter module is suitable for the filter module and/or whether the filter element is authentic or a counterfeit. This enhances the security of the operation of the treatment facility and/or the filter module having the filter element and enables the utilization of the maximum filter capacity without elevated risk. The RFID transponder can, in one embodiment, be formed separately from the filter element in the form of a card and can be fastenable to the filter element. Alternatively, the RFID transponder itself or a further RFID transponder can be integrated permanently into the filter element, for example, in a costly component of the filter element.

Furthermore, in one embodiment, it can be provided that the RFID transponder is configured for the purpose of storing data during a write procedure. In particular, the data can be filter-element-specific data and/or data characterizing the process. In particular, the filter-element-specific data and/or the data characterizing the process can depict a time curve of a parameter. As already indicated above, this enables the recording, for example, of process parameters during the charging of the filter element, for example, the curve of the pressure loss during the operation, the operating hours of the filter element, the filter module associated with the filter element, or, for example, the type of the particles with which the filter element is charged. In a painting booth, this can be the type of paint used, for example. Such items of information can be used for the purpose, in particular if the filter element is replaced before reaching the maximum filter capacity, of estimating the remaining service life of the filter element in the event of a renewed insertion of the filter element and thus maximally utilizing the filter capacity available in the filter element.

Alternatively or additionally, the items of information stored in the RFID transponder can be usable for later utilization steps of the filter element. For example, a history of the materials introduced into the filter element can be helpful in the event of recycling or thermal utilization of the filter element.

The concept of the invention is also implemented by a device having an RFID write/read device for transmitting data to a filter element having an RFID transponder as described above. The device can be a device permanently installed within the treatment facility. Alternatively or additionally, a portable handheld device can be provided for reading out or writing an RFID transponder. The read-out or writing can take place off-line in this case, i.e., without a connection to a central database. Alternatively, a wireless connection to a central database can also be provided.

The object is also achieved by a device for filtering process air for a treatment facility, wherein the device comprises an air guiding system for discharging exhaust air charged with particles from the treatment facility, a separating system for separating the particles located in the exhaust air, and a control unit. The separating system has at least one filter module having at least one replaceable filter element according to the invention as described above for accommodating the separated particles.

It can be provided that the control unit is configured to store a curve of one or more process parameters on the RFID transponder.

Furthermore, it can be provided that the control unit is configured to compare one or more process parameters, in particular the curve of one or more process parameters, to parameters stored on the RFID transponder, in particular to a time curve of parameters stored on the RFID transponder. This represents an additional possibility for checking the integrity of the filter element per se and the interaction between filter module and filter element.

In this context, the control unit can be configured to change or terminate the charging of the filter element in the event of a deviation of a process parameter, in particular a curve of a process parameter, from a process parameter stored on the RFID transponder, in particular a curve of a process parameter stored on the RFID.

### BRIEF DESCRIPTION OF THE DRAWINGS

Exemplary embodiments will be explained in greater detail hereafter on the basis of the drawings. In the figures:

FIG. 1 shows a first embodiment of a filter element according to the invention; and

FIG. 2 shows a second alternative embodiment of a filter element according to the invention.

### DESCRIPTION OF PREFERRED EXEMPLARY EMBODIMENTS

### 1. First Exemplary Embodiment

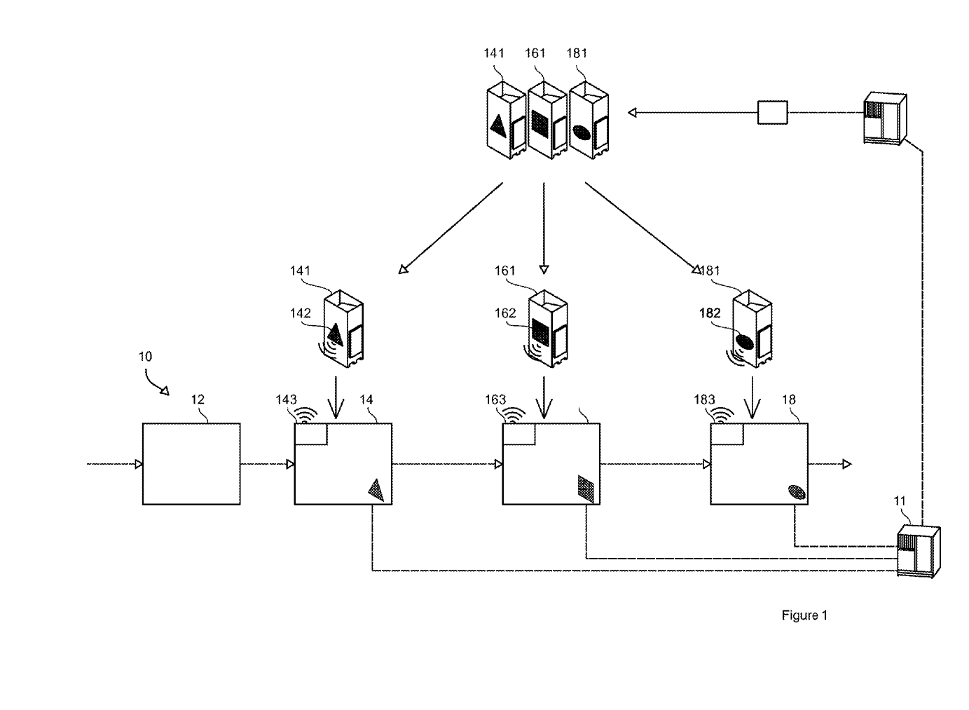

FIG. 1 shows a very schematic illustration of a coating facility 10. Objects to be coated, for example, vehicle bodies, vehicle body components, or wheels, can be conveyed through the coating facility 10 and can be processed or treated at various processing and coating stations 12, 14, 16, 18. The coating facility 10 has a control unit 11 for controlling and regulating the treatment processes taking place in the coating facility 10.

The present exemplary embodiment specifically relates to a painting facility, however, the invention can also be used in other treatment facilities or treatment modules, which require a filtering of process air, for example, drying facilities, cooling facilities, or the like.

A pretreatment takes place at a first treatment station 12. This can be, for example, cleaning, tempering, or the like. After the pretreatment, the object to be coated passes through a first coating station 14, a second coating station 16, and a third coating station 18. An application of a primer takes place at the first coating station. An application of a base paint (“basecoat”) takes place at the second coating station 16, the application of a cover paint (“clearcoat”) is provided at the third coating station 18. The objects to be treated are conveyed by means of a conveyor system between the individual treatment or coating stations 12-18.

The individual coating procedures mentioned here at the coating stations 14-18 require different purification of the process air loaded with particles, for example, overspray, by means of filter modules containing filter elements. For this purpose, for example, different air guiding and separation systems having the corresponding filter modules, which are not described in detail here, can be provided for each coating station 14-18.

In the present embodiment, the filter elements are designed as paint separation units. These can be arranged, for example, as paint mist separation systems below spray booths. The exhaust air arising during a coating procedure is guided through the paint separation units, in which the paint particles are separated. For this purpose, the paint separation units can be designed as surface filters, as depth filters, or as a combination of surface filters and depth filters, for example, can have compartment and/or chamber structures in the form of a flow labyrinth and can be constructed at least partially from a recycling material, for example. The filter elements are cuboid here, for example, and fit on a standard Europallet in the assembled state.

Specifically, the present embodiment provides a different filter element type for each paint separation device of the coating stations 14-18. A first filter element 141 of a first filter element type is provided for the first coating station 14, a second filter element 161 of a second filter element type is provided for the second coating station 16, and a third filter element 181 of a third filter element type is provided for the third coating station 18.

The individual filter elements 141, 161, 181 of the respective filter element type are each provided with an RFID transponder 142, 162, 182. In an alternative embodiment, the filter elements 141, 161, 181 can comprise actively transmitting WLAN or Bluetooth modules instead of a passive RFID transponder. In the present exemplary embodiment, the RFID transponders 142, 162, 182 are shown by a different symbol for each filter element for better differentiation in FIG. 1: the RFID transponder 142 of the first filter element type 141 is symbolized by a triangle, the RFID transponder 162 of the second filter element type 161 is symbolized by a rectangle, and the RFID transponder 182 of the third filter element type 181 is symbolized by an ellipse.

The individual coating stations 14, 16, 18 have corresponding RFID write/read devices 143, 163, 183 for reading out and writing the RFID transponders 142, 162, 182 of the filter elements 141, 161, 181. In an alternative embodiment, the write/read devices 143, 163, 183 could be designed as WLAN base stations or as Bluetooth remote stations.

The individual filter elements 141, 161, 181 are permanently connected to the RFID transponders 142, 162, 182 during the production by the supplier of the filter elements 141, 161, 181. The RFID transponders fulfill multiple functions in this case.

The respective RFID transponder 142, 162, 182 is in the range of the respective RFID write/read device 143, 163, 183 in operation of the coating station 14, 16, 18. The RFID transponder 142, 162, 182 does not have to have visual contact for a data transmission to or from the RFID write/read device 143, 163, 183, whereby this data transmission is substantially less sensitive with respect to soiling.

If no RFID transponders 142, 162, 182 meeting the required criteria are in range of the RFID write/read device, the control unit 11 can establish the absence of a filter element 141, 161, 181 and possibly stop the operation of the respective treatment station 14, 16, 18.

The respective RFID transponder 142, 162, 182 is written with a dataset defined for the associated filter module before an operation. This dataset can comprise multiple parameters, which are suitable for the optimum monitoring of the filter element 141, 161, 181. For example, the increase of the pressure drop at the filter element 141, 161, 181 as a result of the increasing flow resistance with increasing filling of the filter element can be saved. This can be stored, for example, as a third-order polynomial in the RFID transponder 142, 162, 182 and read out by the RFID write/read device 143, 163, 183. With this specification, the control unit 11 of the treatment facility 10 can compute the initial pressure loss of the paint separation device as a function of the volume flow conveyed through the paint separation unit or the filter element 141, 161, 181.

Therefore, corresponding data of the control unit 11 do not have to be made accessible by the operator of the treatment facility 10. This is advantageous in particular if the producer and/or supplier of the filter elements 141, 161, 181 supplies an optimized filter element type, which has a changed (optimized) flow behavior. The corresponding data can be communicated via the RFID transponder 142, 162, 182 via the RFID write/read device 143, 163, 183 to the control unit 11 already with the insertion of the filter element 141, 161, 181 into the treatment station 14, 16, 18.

The RFID transponder 142, 162, 182 can have the filter module type or paint separator type matching with the filter element 141, 161, 181 stored as a further parameter. This enables a check of the correct association of the filter element 141, 161, 181 with the associated filter module or paint separator type. It can thus be ensured that the inserted filter element 141, 161, 181 is also suitable for the filter module type or paint separator type.

The RFID transponder 142, 162, 182 can furthermore have an identifier for the type of the provided coating station, for example, the painting booth. Thus, if the filter element 141, 161, 181 is to be used in a treatment station other than that provided, this can be detected and possibly prevented by the control unit.

In one special embodiment of a filter element 141, 161, 181, a so-called experimental identifier can be coded in the RFID transponder 142, 162, 182. This means that in the case of an insertion of a filter element 141, 161, 181, which has an RFID transponder 142, 162, 182 coded with an experimental identifier, the control unit 11 accepts this filter element type in any case, but puts the respective treatment station 14, 16, 18 or the entire treatment facility 10 into an experimental state. This can include, for example, a corresponding control visualization and analysis and thus enable the testing and/or optimization of specific filter elements.

The RFID transponder 142, 162, 182 can have a verification key in the form of a number, a text, or other symbols, to enable an authentication of the filter element 141, 161, 181. The verification key can be generated individually by an encryption algorithm for each RFID transponder 142, 162, 182. A correct verification key can enable the check of the authenticity of the dataset coded by the producer and/or supplier of the filter element 141, 161, 181 in the RFID transponder. In the case of a permanent and non-detachable connection of the RFID transponder 142, 162, 182 to the filter element 141, 161, 181, the authenticity of the filter element 141, 161, 181 can thus moreover be established. If the check of the verification key after a read-out of the RFID transponder 142, 162, 182 by the RFID read device 143, 163, 183 fails, the control unit 11 can suspend the operation of the coating station 14, 16, 18 or the operation of the entire treatment facility 10, since an incorrect filter element 141, 162, 181 can cause unpredictable damage to the facility. For example, the AES algorithm can be used as an encryption algorithm for generating the verification key.

If a correct filter element to be verified is inserted, the control unit 11 of the treatment facility 10 can permit filling of the filter element up to the maximum possible fill level. In contrast, if a verification is absent or if the RFID transponder is entirely absent, a certain safety margin, i.e., incomplete filling of the filter element can be provided. For this purpose, for example, the maximum pressure drop to be reached at the filter element can be set lower than in the case of verification, for example, only at most 300 Pa.

Individual or all RFID transponders 142, 162, 182 can alternatively or additionally be equipped with a sensor (not shown). Such a sensor can determine, for example, a fill level or similar physical measured variables. The sensor can have the energy required for determining the measured variable provided, for example, by the RFID transponder from the electrical request field. Alternatively or additionally, the sensor can be supplied with a separate power source, for example, a battery or a rechargeable battery.

In operation of the individual coating or treatment stations, process parameters are stored continuously or intermittently on the RFID transponders 142, 162, 182. The data thus stored on the RFID transponders 142, 162, 182 can comprise, for example, the designation of the treatment facility 10, the coating station or the painting booth 14, 16, 18 in which the filter element 141, 161, 181 is used, the position inside the coating station 14, 16, 18, the volume flow conveyed through the filter element 141, 161, 181 at a certain point in time, and the pressure drop taking place at the filter element 141, 161, 181 at a certain point in time.

The pressure drop can also be written on the RFID transponders in specific pressure drop steps and in the case of a fixed volume flow instead of at specific points in time. This enables the production of a filling curve, i.e., a chronological development of the filling of the filter element 141, 161, 181. This permits the operator of the treatment facility and the producer of the filter element 141, 161, 181 analysis options for optimizing the coating process and the production process of the filter element. For example, the service life of the filter elements 141, 161, 181 can be determined and optimum filter element replacement intervals can thus be ascertained. This enables a particularly simple scheduling of delivery cycles for new filter elements and of retrieval cycles for the used filter elements.

Furthermore, optimizations can be carried out within the treatment facility by means of the recordings on the RFID transponder. For example, in painting booths, overspray optimization can be carried out with respect to the location of the filter element, i.e., every running meter of the painting booth. Furthermore, a separation optimization can be carried out in each case. The objects to be treated generally have a certain extension along the conveyance direction and are at different positions within the treatment facility at different points in time during the overall coating procedure. In general one coating element 141, 161, 181 can be associated with each determined position within the treatment facility. It can be ascertained by means of a recording of the overspray quantity separated in a specific filter element 141, 161, 181 whether an excessively large quantity of overspray possibly forms at a specific position and corresponding correction measures can be taken.

If the pressure drop taking place at the filter element reaches, for example, a maximum value predefined in the RFID transponder 142, 162, 182, the filter element 141, 161, 181 is blocked for further operation by the control unit 11. A further use of this filter element 141, 161, 181 in another filter module is no longer possible after this blocking. This substantially enhances the process reliability.

For the disposal of the filter element, the items of information stored in the transponder 142, 162, 182 can be read out and used for the disposal process, for example, with respect to a treatment of certain embedded materials. Subsequently or alternatively, the transponder 142, 162, 182 can be irreversibly erased and thus made unusable.

### 2. Second Embodiment

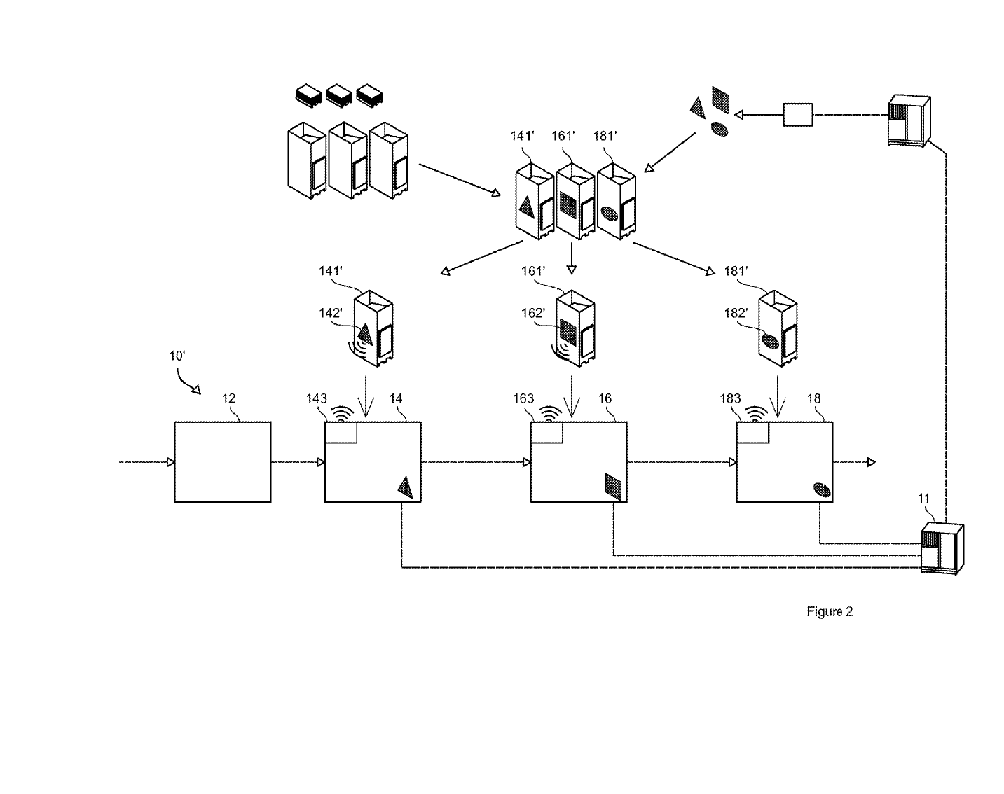

FIG. 2 shows, also in a very schematic illustration, an alternative coating facility 10′. Identical or comparable features are identified by identical reference signs in FIG. 2. In contrast to the coating facility 10 of FIG. 1, in the coating facility 10′ of FIG. 2, a physical separation is provided between RFID transponder 142′, 162′, 182′ and the filter element 141′, 161′, 181′. This means that the operator of the coating facility 10′ is not dependent on purchasing a filter element provided with an RFID transponder from a producer. Rather, the RFID transponder 142′, 162′, 182′ can be acquired separately with a dataset stored thereon and can be coupled to a filter element 141′, 161′, 181′ acquired from another producer. To avoid confusion here, the RFID transponders and the associated filter elements can have an identification recognizable to operating personnel, for example, a color coding or a symbol coding. As soon as the facility controller 11 has identified an RFID transponder 142′, 162′, 182′ coupled to such a filter element 141′, 161′, 181′, the data transmission can be performed as already described above. If the process parameters are stored on the RFID transponders 142′, 162′, 182′ in the course of the filling of a filter element 141′, 161′, 181′ as already described above, a further use of an RFID transponder 142′, 162′, 182′ of a partially-filled filter element 141′, 161′, 181′ cannot be carried out with an unused filter element 141′, 161′, 181′. The pressure drop at an unused filter element would not correspond to the pressure drop of a partially filled filter element. The control unit could initiate the stop of the filling procedure in such a case. Furthermore, the recording of the process parameters on an RFID transponder could also enable a change of a filter element in the meantime and the subsequent reuse of the same filter element.

What is claimed is:

1. A filter element for a filter module for filtering process air for a treatment facility comprising: a communication device, which has an information carrier and a transmitter, and is designed to transmit items of information of the information carrier.

2. The filter element as claimed in claim 1, wherein the communication device is designed as an RFID transponder.

3. The filter element as claimed in claim 1, wherein the communication device is configured to transmit items of information via a WLAN and/or according to the Bluetooth standard.

4. The filter element as claimed in claim 1, wherein the communication device comprises a sensor for acquiring filter-element-specific data.

5. The filter element as claimed in claim 1, wherein the communication device is configured to transmit filter-element-specific data during a read-out procedure.

6. The filter element as claimed in claim 5, wherein the filter-element-specific data include a time curve of the pressure drop of the filter element.

7. The filter element as claimed in claim 2, wherein the filter-element-specific data are configured for an identification and/or an authentication of the filter element.

8. The filter element as claimed in claim 1, wherein the communication unit (142) is configured to store data during a write procedure.

9. The filter element as claimed in claim 8, wherein the data are filter-element-specific data and/or the data are data characterizing the process.

10. The filter element as claimed in claim 9, wherein the filter-element-specific data and/or the data characterizing the process depict a time curve of a parameter.

11. A device for transmitting data to a filter element as claimed in claim 1, comprising: an RFID write/read device.

12. A device for filtering process air of a treatment facility, comprising:
an air guiding system for discharging exhaust air charged with particles from the treatment facility,
a separation system for separating the particles located in the exhaust air, and
a control unit, wherein
the separation system has at least one filter module having at least one replaceable filter element for accommodating the separated particles as claimed in claim 1.

13. The device as claimed in claim 12, wherein the control unit is configured to store a curve of one or more process parameters on the RFID transponder.

14. The filter element as claimed in claim 6, wherein the filter-element-specific data are configured for an identification and/or an authentication of the filter element.
